(19) United States
(12) Patent Application Publication
(10) Pub. No.: US 2025/0011559 A1
(43) Pub. Date: Jan. 9, 2025

(54) FOAM INSULATION DOUGH

(71) Applicant: UT-Battelle, LLC, Oak Ridge, TN (US)

(72) Inventors: Meghan Lamm, Oak Ridge, TN (US); Tolga Aytug, Knoxville, TN (US); Katie Copenhaver, Knoxville, TN (US); Kai Li, Farragut, TN (US)

(21) Appl. No.: 18/761,728

(22) Filed: Jul. 2, 2024

Related U.S. Application Data
(60) Provisional application No. 63/525,173, filed on Jul. 6, 2023.

(51) Int. Cl. C08J 9/18; B29C 43/00; B29C 43/02; B29C 43/52; B29K 21/00; B29K 63/00; B29K 105/16; B29K 509/08; C08G 59/24; C08G 59/50; C08J 9/00; C08K 7/28

(52) U.S. Cl. CPC C08J 9/18; C08G 59/245; C08G 59/504; C08J 9/0066; C08K 7/28; B29C 43/003; B29C 43/02; B29C 43/52; B29K 2021/006; B29K 2063/00; B29K 2105/165; B29K 2509/08; C08J 2203/22; C08J 2363/02; C08K 2201/001

(57) ABSTRACT

A moldable thermal insulation composite is provided. The composite includes a thermoset polymer, a curing agent, a thermal conductivity filler, and a physical blowing agent. The thermal conductivity filler includes a hollow-interior glass sphere (HGS) or porous-shell hollow-interior glass sphere (PHGS). The physical blowing agent includes an expandable thermoplastic microsphere (EMS). The thermal conductivity filler is present in the composite in an amount of 0.1 to 49.9 wt. %. The physical blowing agent is present in the composite in an amount of 0.1 to 49.9 wt. %. The thermal conductivity filler and the physical blowing agent are present in the composite in a combined amount of 20 to 50 wt. %. A method of manufacturing a thermal insulation composite is also provided.

### CROSS-REFERENCE TO RELATED APPLICATIONS

This application claims the benefit of U.S. Provisional Application 63/525,173, filed Jul. 6, 2023, the disclosure of which is hereby incorporated by reference.

### STATEMENT REGARDING FEDERALLY SPONSORED

### RESEARCH AND DEVELOPMENT

This invention was made with government support under Contract No. DE-AC05-00OR22725 awarded by the U.S. Department of Energy. The government has certain rights in the invention.

### FIELD OF THE INVENTION

The present invention relates to a moldable insulation foam.

### BACKGROUND OF THE INVENTION

Insulation has revolutionized the building and construction sectors by providing a comfortable, lower-energy consumption living environment. Changes in building standards have led to thinner, higher performance insulation, such as thermoset foams like polyurethane and polyisocyanurate. Thermoset foam insulation is generally produced as panels using injection or compression molding processes in industry or is sold as a two-part sprayable foam formulation for direct use. Unfortunately, when the foam insulation is produced via injection or compression molding the dimensions of the panels are limited by the mold. Molds are expensive to produce and specific to one set of dimensions. Foam insulation produced using sprayable foam formulations produce hazardous fumes and particulate during installation that create health and environmental concerns. Therefore, there remains room for improvement in the field of foam insulation.

### SUMMARY OF THE INVENTION

A moldable thermal insulation composite is provided. The composite includes a thermoset polymer, a curing agent, a thermal conductivity filler, and a physical blowing agent. The thermal conductivity filler includes a hollow-interior glass sphere (HGS) or porous-shell hollow-interior glass sphere (PHGS). The thermal conductivity filler is present in the composite in an amount of 0.1 to 49.9 wt. %. The physical blowing agent includes an expandable thermoplastic microsphere (EMS). The physical blowing agent is present in the composite in an amount of 0.1 to 49.9 wt. %. The thermal conductivity filler and the physical blowing agent are present in the composite in a combined amount of 20 to 50 wt. %.

The thermoset polymer is a liquid at room temperature. In certain embodiments, the thermoset polymer is an epoxy polymer. The thermoset polymer may be a bisphenol A diglycidyl ether. In some embodiments, the curing agent is an amine crosslinker. The curing agent may be triamine including a poly(propylene glycol) backbone. The thermal conductivity filler may include a PHGS.

A method of manufacturing a thermal insulation composite is also provided. The method includes the step of combining a thermoset polymer, a curing agent, a thermal conductivity filler, and a physical blowing agent to vie a composite composition. The thermal conductivity filler and physical blowing agent increase the viscosity of the mixture, allowing the mixture to undergo shape formation without the need for a mold. The thermal conductivity filler includes a hollow-interior glass sphere (HGS) or porous-shell hollow-interior glass sphere (PHGS) in an amount of 0.1 to 49.9 wt. %. The physical blowing agent includes an expandable thermoplastic microsphere (EMS) in an amount of 0.1 to 49.9 wt. %. The thermal conductivity filler and the physical blowing agent are present in the composite in a combined amount of 20 to 50 wt. %.

In specific embodiments, the step of forming the composite composition into an uncured insulation article includes molding the composite composition. The step of molding the composite composition may further include disposing the composite composition with a mold sandwiched between two end plates with a pair of gaskets between the custom mold and the end plates. The step of molding the composite composition may include compression molding the composite composition in a warm press or oven. The step of foaming the composite composition can also include rolling out the foam or molding it into a desired shape prior to the oven. The step of forming the composite composition into an uncured insulation article includes the additive manufacture of the uncured insulation article using the composite composition.

### DETAILED DESCRIPTION OF THE CURRENT EMBODIMENTS

A moldable thermal insulation composite (“the composite”) is provided. The composite includes a thermoset polymer, a curing agent, a thermal conductivity filler, and a physical blowing agent. The thermal conductivity filler includes a hollow-interior glass sphere (HGS) or porous-shell hollow-interior glass sphere (PHGS). The physical blowing agent includes an expandable thermoplastic microsphere (EMS). The thermal conductivity filler is present in the composite in an amount of 0.1 to 49.9 wt. %. The physical blowing agent is present in the composite in an amount of 0.1 to 49.9 wt. %. The thermal conductivity filler and the physical blowing agent are present in the composite in a combined amount of 20 to 50 wt. %. The composite provides excellent moldability and a tailorable viscosity determined by the relative weight loading of the thermal conductivity filler and the physical blowing agent.

The composite includes a thermoset polymer. Generally, the thermoset polymer is a liquid at room temperature (i.e., 20-22° C.) and at atmospheric pressure (˜1 atm). The thermoset polymer may be selected from any thermoset polymer that is liquid at room temperature and atmospheric pressure including: epoxy resins, polyurethane resins, unsaturated polyester resins, vinyl ester resins, silicone resins, phenolic resins (novolac resins), or a combination thereof. In some embodiments, the thermoset polymer comprises, alternatively consists essentially of, alternatively consists of an epoxy resin. In specific embodiments, the epoxy resin comprises, alternatively consists essentially of, alternatively consists of bisphenol A diglycidyl ether.

The composite also includes a curing agent. The curing agent is generally selected in view of the thermoset polymer such that it effectively facilitates the curing of the thermoset polymer. The curing agent may comprise a crosslinker, a catalyst, a photo-initiator, or a combination thereof. In embodiments where the thermoset polymer comprises an epoxy resin, the curing agent may comprise the crosslinker selected from one of an amine crosslinker (e.g., triethylenetetramine (TETA), diethylenetriamine (DETA), ethylenediamine (EDA), diaminodiphenylmethane (DDM), or m-phenylenediamine (m-PDA)), an anhydride crosslinker (e.g., phthalic anhydride, hexahydrophthalic anhydride (HHPA), or methylhexahydrophthalic anhydride (MHHPA)), a phenolic crosslinker, or a thiol crosslinker (e.g., pentaerythritol tetrakis(3-mercaptopropionate) (PETMP)).

In embodiments where the thermoset polymer comprises a polyurethane resin the curing agent may comprise the crosslinker selected from one of an isocyanate crosslinker (e.g., methylene diphenyl diisocyanate (MDI), toluene diisocyanate (TDI), hexamethylene diisocyanate (HDI), or isophorone diisocyanate (IPDI)), or a polyol crosslinker (e.g., polyether polyols, polyester polyols, or castor oil). In embodiments where the thermoset polymer comprises a silicone resin the curing agent may comprise the crosslinker selected from one of a peroxide crosslinker (e.g., benzoyl peroxide, dicumyl peroxide, 2,5-dimethyl-2,5-di(tert-butylperoxy)hexane), an amine crosslinker (e.g., triethylamine, ethanolamine, hexamethylenetetramine), or a siloxane crosslinker. In embodiments where the thermoset polymer comprises a phenolic resin the curing agent may comprise the crosslinker selected from one of a hexamethylenetramine (hexamine) crosslinker, a formaldehyde crosslinker, or a paraformaldehyde crosslinker.

In embodiments where the thermoset polymer comprises an epoxy resin, the curing agent may comprise the catalyst selected from one of a Lewis acid catalyst (e.g., boron trifluoride, aluminum chloride, tin chloride), a imidazole catalyst (e.g., 2-methylimidazole, 2-phenylimidazole, 1-methylimidazole), a tertiary amine catalyst (e.g., triethylamine (TEA), dimethylaminomethylphenol (DMAMP), benzyl dimethylamine (BDMA), 2,4,6-tris(dimethylaminomethyl)phenol (DMP-30)), a phosphine catalyst (e.g., triphenylphosphine (TPP), triethylphosphine (TEP)), a carboxylate catalyst (e.g., sodium benzoate, zinc octoate, potassium octoate), a metal complex catalyst (e.g., zinc acetylacetonate, cobalt acetylacetonate, manganese acetylacetonate), or a urea-based catalyst (e.g., phenyl urea, isophorone diurea). It will be appreciated that amines can be used as catalysts, crosslinkers, or can play a dual role.

In embodiments where the thermoset polymer comprises a polyurethane resin the curing agent may comprise the crosslinker selected from one of a tin catalyst (e.g., dibutyltin dilaurate (DBTDL), stannous octoate, dibutyltin diacetate, dibutyltin dimaleate), an amine catalyst (e.g., triethylamine (TEA), dimethylcyclohexylamine (DMCHA), triethylenediamine (TEDA), N,N-dimethylcyclohexylamine (DMCHA), bis(2-dimethylaminoethyl) ether (BDMAEE), N,N′-dimethylpiperazine)), a bismuth catalyst (e.g., bismuth neodecanoate, bismuth carboxylate), a zinc catalyst (e.g., zinc octoate, zinc neodecanoate), a potassium catalyst (e.g., potassium acetate, potassium octoate), or a metal catalyst (e.g., iron acetylacetonate, mercury octoate).

In embodiments where the thermoset polymer comprises a silicone resin the curing agent may comprise the catalyst selected from a platinum catalyst (e.g., platinum-divinyltetramethyldisiloxane complex, platinum cyclovinylmethylsiloxane complex, chloroplatinic acid, platinum-octyl alcohol complex), phophonium salts (e.g., tetrakis(hydroxypropyl)phosphonium chloride (THPC) or tetrakis(hydroxyethyl)phosphonium chloride (THEPC)), or a tin catalyst (e.g., dibutyltin dilaurate (DBTDL), stannous octoate, bituyltin diacetate, bituyltin dioctoate).

In embodiments where the thermoset polymer comprises a phenolic resin the curing agent may comprise the catalyst selected from hexamethylenetetramine, ammonium chloride, zinc chloride, magnesium oxide, phosphoric acid, sulfuric acid, alkali hydroxides, or boric acid.

In embodiments where the curing agent includes a photoinitiator the photoinitiator is generally selected from a cleavage type photoinitiator or a hydrogen abstraction photoinitiator. The cleavage type photoinitiator may comprise a benzoin ether, an acylphosphine oxide, a benzil derivative, an α-hydroxy ketone, an α-amino ketone, or an oxime ester. The hydrogen abstraction type photoinitiator may comprise a benzophenone, a thioxanthone, a anthraquinone, or a camphorquinone. In some embodiments, the photoinitiator comprises an onium salt or a ferrocene derivative.

The thermal conductivity filler includes a hollow-interior glass sphere (HGS) or porous-shell hollow-interior (PHGS). The thermal conductivity filler generally provides enhanced flame retardancy, increased mechanical strength, and facilitates excellent insulation performance by decreasing the overall thermal conductivity of the polymer system. The thermal conductivity filler comprises a hollow glass sphere (HGS) or a porous wall-hollow glass sphere (PHGS). Generally, the thermal conductivity filler comprises a multitude of hollow glass spheres or porous wall-hollow glass spheres. HGS and PHGS are spherical in shape with a hollow central cavity. HGS and PHGS have a hollow central cavity having diameters in a range of 10 to 120 μm surrounded by thin silica walls of 0.5 to 2 μm in thickness. In specific embodiments, the hollow central cavity has a diameter of about 50 μm and a silica wall of 1 μm. The HGS and PHGS may be coated or uncoated. The coating may be a polymer coating, a metal coating, a ceramic coating, or a composite coating. Generally, the coating will be a polymer coating. Notably, the silica HGS and PHGS feature a relatively low density, greater chemical inertness, strong mechanical properties, and much lower thermal conductivity when compared with solid borosilicate glasses (0.1 W/m·K versus 1.4 W/m·K, respectively). These superior properties of silica HGS and PHGS facilitate the excellent mechanical strength and lightweight character of the composite. The superior properties of the silica HGS and PHGS further result in lower flammability and thermal conductivity of the composite when compared to conventional insulation foams composed of pristine materials. The thermal conductivity filler is present in the composite in an amount of from 0.1 to 49.9 wt. %, alternatively 0.1 to 25 wt. %, alternatively 25 to 49.9 wt. %, alternatively 5 to 15 wt. %, alternatively 35 to 45 wt. %, alternatively 15 to 35 wt. %.

In some embodiments, the thermal conductivity filler comprises, alternatively consists essentially of, alternatively consists of PHGS. PHGS provides additional benefits to the composite when the (B) thermal conductivity filler comprises PHGS. Each individual PHGS defines a tortuous network of nanometer-scale pores in the shell structure which produce an even lower density than is typical of HGS. These pores are typically between 100-2000 Å in size. Each individual PHGS features a highly permeable surface with increased surface area. This increased surface area helps to strengthen the interface of the thermal conductivity filler with the thermoset polymer and increase the mechanical resiliency of the composite.

The physical blowing agent further facilitates the excellent insulation performance of the composite by increasing the porosity of the composite. Increasing porosity of insulation foams is generally desired because air has a lower thermal conductivity (0.0259 W/m·K at 20° C. and 1 bar) than the other components (A) and (B) in the composite such as thermosets (˜0.1 W/m·K) and thermoplastics (˜0.2 W/m·K). Incorporation of the physical blowing agent effectively improves the thermal performance of the composite by minimizing the thermal conductivity contribution of the solid polymer fraction and increasing the formation of physical discontinuities within the foamed structure of the composite. The physical blowing agent includes an expandable thermoplastic microsphere (EMS). Generally, the physical blowing agent includes a multitude of EMS. EMS are a safer and more environmentally friendly way for producing thermoplastic insulation foams than conventional blowing agents. Each EMS includes a thin exterior polymer membrane shell that encapsulates a non-halogenated alkane-based solvent. If the EMS is processed at a temperature that exceeds a glass transition temperature (T_{g}) of the polymer membrane shell.

As the temperature approaches the T_{g} the polymer membrane shell softens and the internal alkane-based solvent boils, resulting in expansion of the softened polymer membrane shell and an increase in the volume of the EMS. The EMS is generally selected such that the EMS has an expansion temperature above a melting or softening temperature of the thermoset polymer, but has a decomposition temperature above the melting or softening temperature used in the thermoset polymer. The physical blowing agent is present in the composite in an amount of from 0.1 to 49.9 wt. %, alternatively 0.1 to 25 wt. %, alternatively 25 to 49.9 wt. %, alternatively 5 to 15 wt. %, alternatively 35 to 45 wt. %, alternatively 15 to 35 wt. %.

The thermal conductivity filler and the physical blowing agent are present in the composite in a combined amount of 20 to 50 wt. %, alternatively 25 to 45 wt. %, alternatively 30 to 40 wt. %, alternatively 20 to 30 wt. %, alternatively 40 to 50 wt. %. The weight loading of the thermal conductivity filler, the physical blowing agent, and the combined weight loading of both components will be selected in view of the desired viscosity.

The composition has several advantages associated with the specific weight loading and combination of elements included in the composition. The composition is generally a dough. The composition is generally shear thinning, allowing for excellent ease in extrusion and processability. The composition can be extruded and rolled out, allowing for greater convenience in the manufacturing of insulation boards. In some embodiments, the composition has a density of from 0.4 to 0.45 g/cm³ and a thermal resistivity value of from 4.65 to 4.75 R/in.

A method of manufacturing a thermal insulation composite is also provided. The method includes the step of combining a thermoset polymer, a curing agent, a thermal conductivity filler, and a physical blowing agent to give a composite composition. The thermal conductivity filler includes a hollow-interior glass sphere (HGS) or porous-shell hollow-interior glass sphere (PHGS) in an amount of 0.1 to 49.9 wt. %. The physical blowing agent includes an expandable thermoplastic microsphere (EMS) in an amount of 0.1 to 49.9 wt. %. The thermal conductivity filler and the physical blowing agent are present in the composite in a combined amount of 20 to 50 wt. %.

In some embodiments, the step of forming the composite composition into an uncured insulation article includes molding the composite composition. The step of molding the composite composition may include disposing the composite composition within a mold sandwiched between two end plates with a pair of gaskets between the custom mold and the end plates. The step of molding the composite composition may include compression molding the composite composition in a warm press or oven. The step of foaming the composite composition can also include rolling out the foam or molding it into a desired shape prior to the oven. In certain embodiments, the step of forming the composite composition into an uncured insulation article includes the additive manufacture of the uncured insulation article using the composite composition.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular. If not otherwise defined herein, “about” is defined as within ±25%, alternatively ±10%, or alternatively ±5%.

1. A moldable thermal insulation composite, the composite comprising:
(A) a thermoset polymer;
(B) a curing agent;
(C) a thermal conductivity filler comprising a hollow-interior glass sphere (HGS) or porous-shell hollow-interior glass sphere (PHGS), the (C) thermal conductivity filler being present in the composite in an amount of 0.1 to 49.9 wt. %;
(D) a physical blowing agent comprising an expandable thermoplastic microsphere (EMS), the (D) physical blowing agent being present in the composite in an amount of 0.1 to 49.9 wt. %; and
wherein the (C) thermal conductivity filler and the (D) physical blowing agent are present in the composite in a combined amount of 20 to 50 wt. %.

2. The composite of claim 1, wherein the (A) thermoset polymer is a liquid at room temperature.

3. The composite of claim 1, wherein the (A) thermoset polymer is an epoxy polymer.

4. The composite of claim 3, wherein the (A) thermoset polymer is bisphenol A diglycidyl ether.

5. The composite of claim 3, wherein the (B) curing agent is an amine crosslinker.

6. The composite of claim 5, wherein the (B) curing agent is triamine comprising a poly(propylene glycol) backbone.

7. The composite of claim 1, wherein the (C) thermal conductivity filler comprises a PHGS.

8. A method of manufacturing a thermal insulation composite, the method comprising the steps of:
combining:
(A) a thermoset polymer,
(B) a curing agent,
(C) a thermal conductivity filler, and
(D) a physical blowing agent to give a composite composition;
forming the composite composition into an uncured insulation article; and
heating the uncured insulation article to give a cured insulation article; and
wherein the (C) thermal conductivity filler comprises a hollow-interior glass sphere (HGS) or porous-shell hollow-interior glass sphere (PHGS) in an amount of 0.1 to 49.9 wt. %;
wherein the (D) physical blowing agent comprises an expandable thermoplastic microsphere (EMS) in an amount of 0.1 to 49.9 wt. %; and
wherein the (C) thermal conductivity filler and the (D) physical blowing agent are present in the composite in a combined amount of 20 to 50 wt. %.

9. The method of claim 8, wherein the step of forming the composite composition into an uncured insulation article comprises molding the composite composition.

10. The method of claim 9, wherein the step of molding the composite composition comprises disposing the composite composition within a mold sandwiched between two end plates with a pair of gaskets between the mold and the end plates.

11. The method of claim 10, wherein the step of molding the composite composition comprises compression molding the composite composition in a warm press or oven.

12. The method of claim 8, wherein the step of forming the composite composition into an uncured insulation article comprises the additive manufacture of the uncured insulation article using the composite composition.
